(19) United States
(12) Patent Application Publication
(10) Pub. No.: US 2017/0060380 A1
(43) Pub. Date: Mar. 2, 2017

(54) ELECTRONIC DEVICE WITH SYSTEM OPTIMIZATION FUNCTION AND SYSTEM OPTIMIZATION METHOD THEREOF

(71) Applicant: HON HAI PRECISION INDUSTRY CO., LTD., New Taipei (TW)

(72) Inventor: LI-ZHANG HUANG, New Taipei (TW)

(21) Appl. No.: 14/886,695

(22) Filed: Oct. 19, 2015

(30) Foreign Application Priority Data
Aug. 28, 2015 (CN) 201510538106.1

(51) Int. Cl. G06F 3/0481; G06F 9/50; G06F 3/0484

(52) U.S. Cl. CPC G06F 3/04817; G06F 3/04845; G06F 9/505

(57) ABSTRACT

A system optimization method includes adding a first mark on an icon of an application when the application is started in response to a starting operation of a user, displaying the first mark on a display area of a display device on an electronic device, checking whether a system load of the electronic device is greater than or equal to a first predetermined value, when the system load of the electronic device is greater than or equal to the first predetermined value, replacing the first marks on the icons of all of the started applications with second marks and displaying the second marks on the display area, closing at least one of the started applications and removing the second marks on the icons of the closed applications.

### CROSS-REFERENCE TO RELATED APPLICATIONS

This application claims priority to Chinese Patent Application No. 201510538106.1 filed on Aug. 28, 2015, the contents of which are incorporated by reference herein.

### FIELD

The subject matter herein generally relates to system optimization technology, and particularly to an electronic device with a system optimization function and a system optimization method.

### BACKGROUND

Nowadays, users install many applications such as, chat programs, games, etc. in intelligent electronic devices, such as smart phones, tablet computers, etc. When using the intelligent electronic devices, many applications will remain running in the background of the intelligent electronic device which will cause the electronic device to be overloaded and operate slowly.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an electronic device with a system optimization function of one embodiment.

FIG. 2 is a diagrammatic view illustrating an embodiment of a display area in which first marks are displayed on icons of running applications.

FIG. 3 is a diagrammatic view illustrating an embodiment of a display area in which second marks are displayed on the icons of the running applications.

FIG. 4 is a diagrammatic view illustrating an embodiment of the display area of FIG. 2 in which the first marks are displayed on the icons of the remaining running applications.

FIG. 5 is a flowchart illustrating an embodiment of a system optimization method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

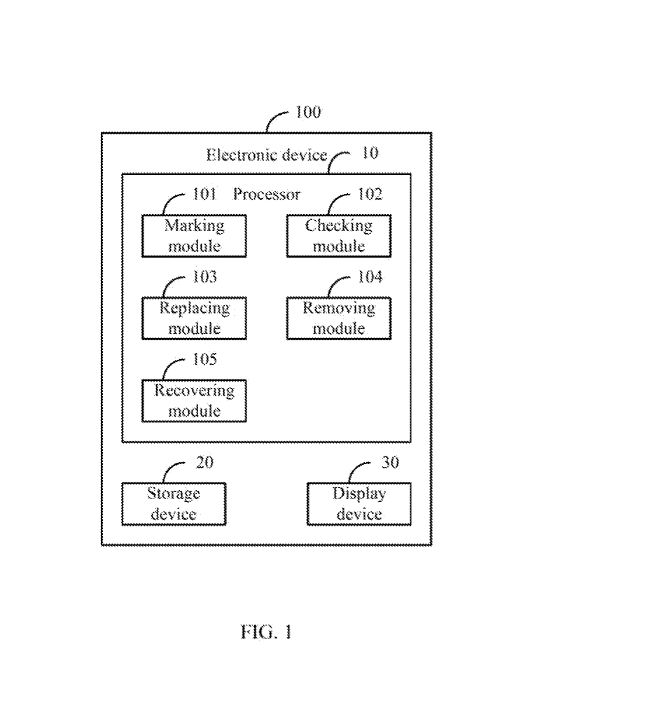

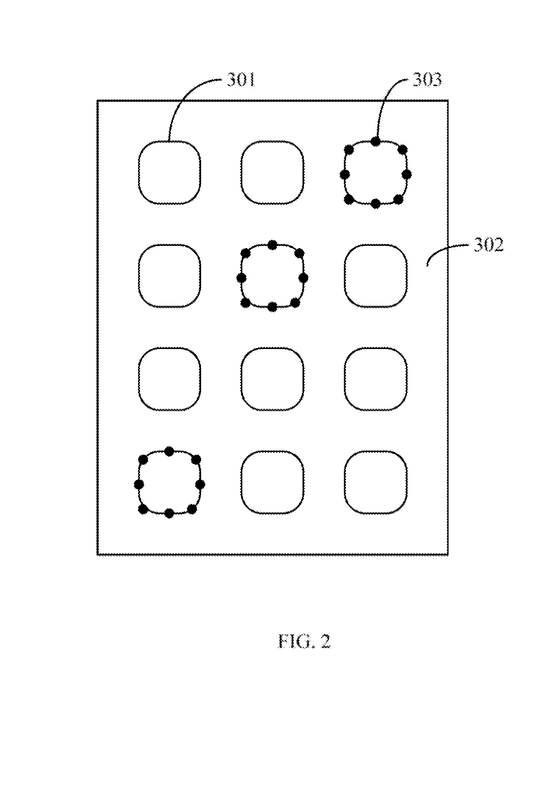

FIG. 1 illustrates a block diagram of an electronic device 100 with a system optimization function. The electronic device 100 includes, but is not limited to, a processor 10, a storage device 20, and a display device 30. A number of applications are installed on the electronic device 100, the applications are stored in the storage device 20. As illustrated in FIG. 2, the display device 30 defines a display area 302, a number of icons 301 of the applications are displayed in the display area 302. In the illustrated embodiment, the display area 302 is an area which is encircled by a frame line. In other embodiments, the display area 302 can be displayed as a floating window. In the illustrated embodiment, the display device 30 can be a touch screen, the electronic device 100 can be smart phone, tablet computer, personal digital assistant (PDA), or other suitable electronic devices. FIG. 1 illustrates only one example of the electronic device 100 and other examples can include more or fewer components than illustrated, or have a different configuration of the various components in other embodiments.

In the illustrated embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium. The at least one processor 10 can be a central processing unit (CPU), a microprocessor, or other data processor chip that performs functions of the electronic device 100.

FIG. 1 illustrates that the at least one processor 10 includes a marking module 101, a checking module 102, a replacing module 103, a removing module 104, and a recovering module 105. The modules 101-105 of the processor 10 can be collections of software instructions stored in the storage device 20 of the electronic device 100 and executed by the processor 10. The modules 101-105 of the processor 10 also can include functionality represented as hardware or integrated circuits, or as software and hardware combinations, such as a special-purpose processor or a general-purpose processor with special-purpose firmware.

The marking module 101 adds a first mark 303 on an icon 301 of an application when the application is started in response to a starting operation, and displays the first mark 303 on the display area 302. In the illustrated embodiment, the starting operation can be clicking or double-clicking executed by a user on the icon 301 of the application.

As illustrated in FIG. 2, when a number of applications of the electronic device 100 are started, the first mark 303 is displayed on the icon 301 of each started application. In the illustrated embodiment, the first mark 303 can be a dot. When the application is started, the marking module 101 adds one or more dots on a margin of the icon 301 of the started application. In an alternative embodiment, the first mark 303 can be a green highlight, when the application is started, the marking module 101 can use green color to highlight the margin of the icon 301 of the started application. In other embodiments, the first mark 303 further can be other special signs, highlight with other colors, or any other mark. The position of the first mark 303 is not limited to the margin of the icon 301, the position of the first mark 303 further can be set on other positions of the icon 301 as needed.

The checking module 102 checks whether a system load of the electronic device 100 is greater than or equal to a first predetermined value. In the illustrated embodiment, the system load can be a CPU utilization, and the first predetermined value can be a percent value determined by the user, such as ninety percent, the checking module 102 determines whether the system load is greater than or equal to ninety percent by checking the CPU utilization of the electronic device 100. In other embodiments, the system load can be a quantity of the started applications, and the first predetermined value is determined by the user, such as fifteen, the checking module 102 determines whether the quantity of the started applications is greater than or equal to fifteen to check the system load.

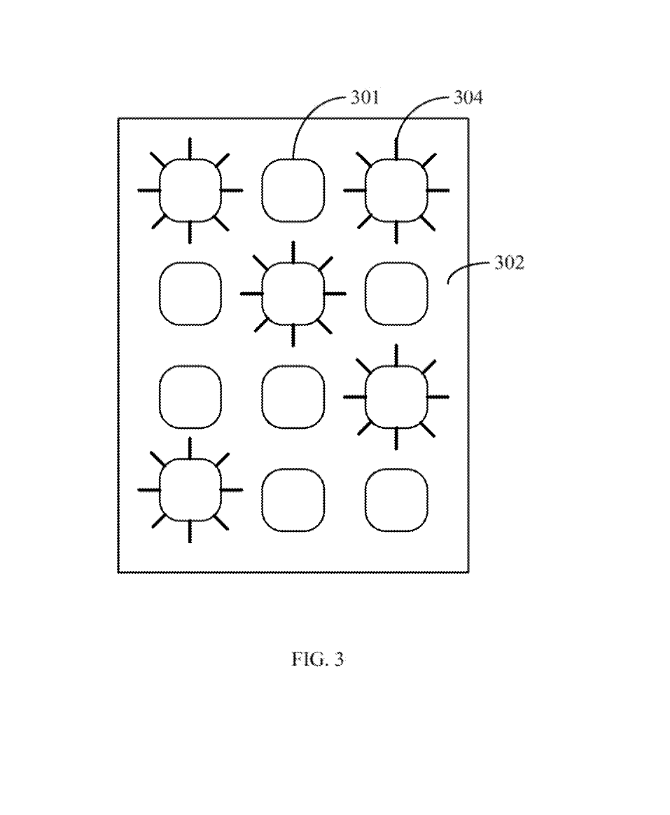

When the checking module 102 determines that the system load of the electronic device 100 is greater than or equal to the first predetermined value, the replacing module 103 replaces the first marks 303 on the icons 301 of all of the started applications with second marks 304, and displays the second marks 304 on the display area 302. As illustrated in FIG. 3, when the system load of the electronic device 100 is greater than or equal to the first predetermined value, which indicates that the system load of electronic device 100 is high, the replacing module 103 replaces the first marks 303 with the second marks 304 to remind the user to close some of the started applications, thus reducing the system load of the electronic device 100.

In the illustrated embodiment, the second mark 304 can be a line, the replacing module 103 replaces the one or more dots on the icons 301 of the started applications with one or more lines correspondingly. In an alternative embodiment, the second mark 304 can also be a red highlight, when the system load of the electronic device 100 is greater than or equal to the first predetermined value, the replacing module 103 can use red to highlight the margin of the icon 301 of the started application instead of the green. In other embodiments, the second mark 304 can be any other removable marks which are different from the first mark 303.

The removing module 104 closes at least one of the started applications, and removes the second marks 304 on the icons 301 of the closed applications. In the illustrated embodiment, the removing module 104 closes at least one of started applications in response to a stop operation of the user, for example, the stop operation can be that the user presses a finger on the icon 301 of one started applications to select the application, and drags the icon 301 of the application out of the display area 302, then the removing module 104 closes the application. When the user releases the icon 301 of the application, the removing module 104 controls the icon 301 to return to an original position in the display area 302, and removes the second marks 304 on the icon 301. In other embodiments, the removing module 104 can close the at least one of the started applications in sequence according to a starting time of the started applications, for example, the removing module 104 can close first five started applications in sequence.

The checking module 102 further checks whether the system load of the electronic device 100 is less than or equal to a second predetermined value. In the illustrated embodiment, the second predetermined value can be a percent value determined by the user, such as forty percent, the checking module 102 determines whether the system load is less than or equal to forty percent by checking the CPU utilization of the electronic device 100. In other embodiments, the first predetermined value is determined by the user, such as five, the checking module 102 determines whether the quantity of the stated application is less than or equal to five to check the system load.

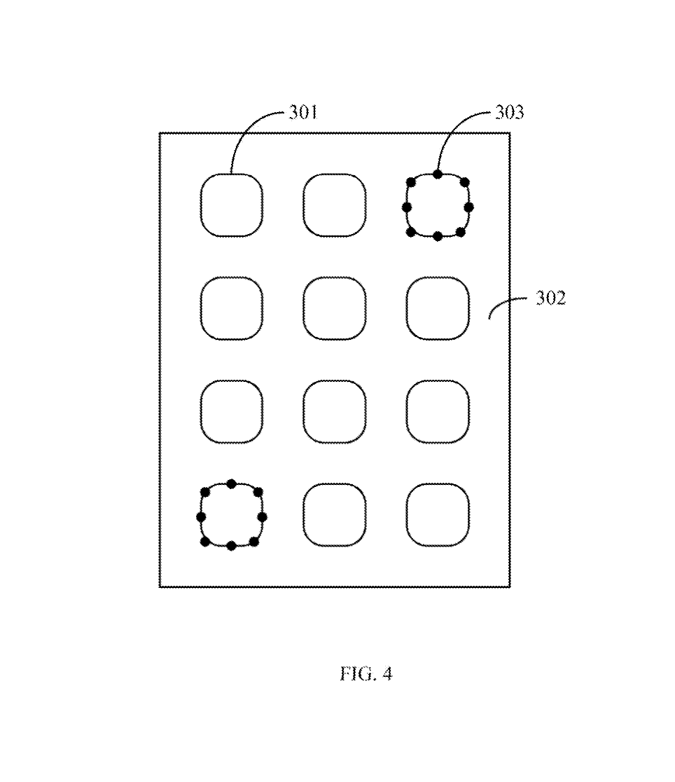

When the checking module 102 determines that the system load of the electronic device 100 is less than or equal to the second predetermined value, the recovering module 105 recovers the second marks 304 on the icons 301 of the remaining started applications to the first marks 303. When the system load of the electronic device 100 is less than or equal to the second predetermined value, which indicates that the system load of the electronic device 100 is low and the electronic device 100 is running better. As illustrated in FIG. 4, when the system load of the electronic device 100 is less than or equal to the second predetermined value, the recovering module 105 recovers one or more lines on the icons 301 of the remaining started applications to the one or more dots, thus reminding the user that the electronic device 100 is running better.

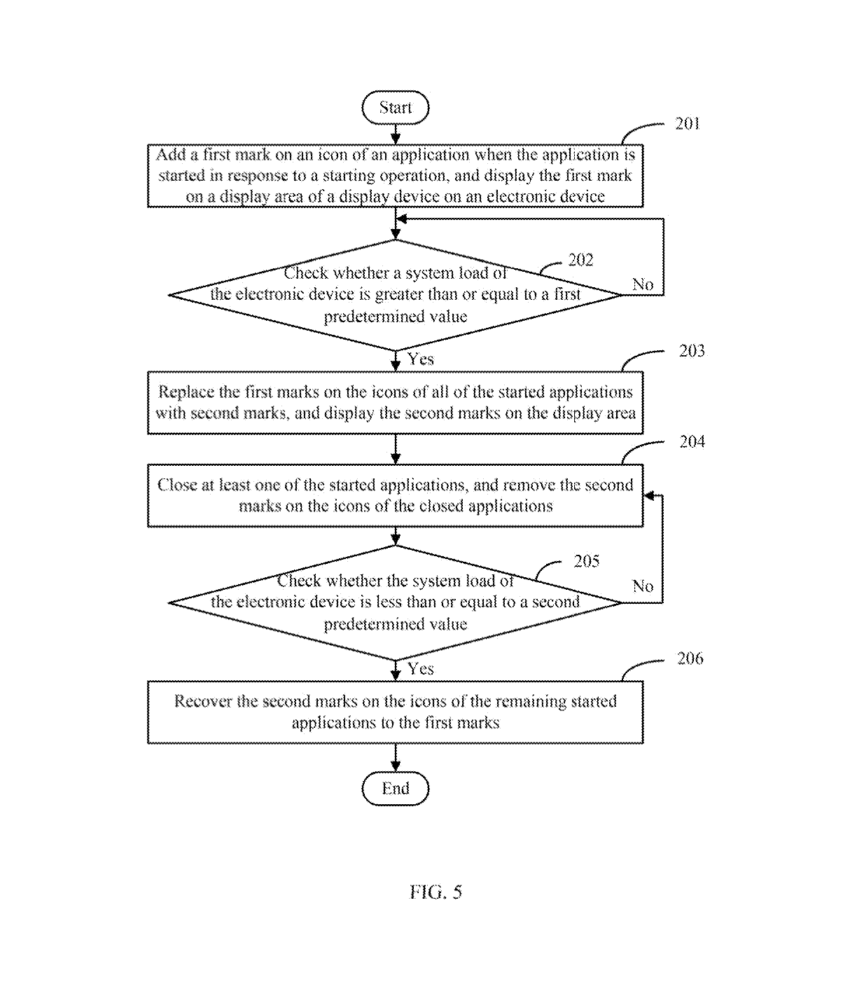

FIG. 5 illustrates a flowchart of an embodiment of a system optimization method. The method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the example method. Furthermore, at least one order of blocks is by example only and the order of the blocks can be changed. Additional blocks may be added or fewer blocks may be utilized, without departing from this disclosure. The example method can begin at block 201.

At block 201, a marking module adds a first mark on an icon of an application when the application is started in response to a starting operation, and displays the first mark on a display area of a display device on an electronic device.

At block 202, a checking module checks whether a system load of the electronic device is greater than or equal to a first predetermined value. If the system load of the electronic device is greater than or equal to the first predetermined value, the procedure goes to block 203, otherwise, the procedure repeats block 202.

At block 203, a replacing module replaces the first marks on the icons of all of the started applications with second marks, and displays the second marks on the display area.

At block 204, a removing module closes at least one of the started applications, and removes the second marks on the icons of the closed applications.

At block 205, the checking module further checks whether the system load of the electronic device is less than or equal to a second predetermined value. If the system load of the electronic device is less than or equal to the second predetermined value, the procedure goes to block 206, otherwise, the procedure goes back to block 204.

At block 206, a recovering module recovers the second marks on the icons of the remaining started applications to the first marks

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device with a system optimization function comprising:
a display device;
at least one processor coupled to the display device; and
a storage device coupled to the at least one processor and configured to store a plurality of applications and a plurality of instructions for execution by the processor to cause the at least one processor to:
add, when the application being started in response to a starting operation, a first mark on an icon of an application;
display the first mark on a display area of the display device;
check whether a system load of the electronic device is greater than or equal to a first predetermined value;
replace, when the system load of the electronic device is greater than or equal to the first predetermined value, the first marks on the icons of all of the started applications with second marks; and
display the second marks on the display area.

2. The electronic device according to claim 1, wherein the at least one processor is further caused to:
close at least one of the started applications; and
remove the second marks on the icons of the closed applications.

3. The electronic device according to claim 2, wherein the at least one processor is further caused to:
check whether the system load of the electronic device is less than or equal to a second predetermined value; and
recover, when the system load of the electronic device is less than or equal to the second predetermined value, the second marks on the icons of the remaining started applications to the first marks.

4. The electronic device according to claim 3, wherein the system load of the electronic device is a CPU utilization or a quantity of the started applications.

5. The electronic device according to claim 2, wherein the at least one processor is caused to close the at least one of the started applications in response to a stop operation.

6. The electronic device according to claim 1, wherein the first mark is a dot or a green highlight, the second mark is a line or a red highlight.

7. A system optimization method comprising:
adding a first mark on an icon of an application when the application is started in response to a starting operation of a user;
displaying the first mark on a display area of a display device on an electronic device;
checking whether a system load of the electronic device is greater than or equal to a first predetermined value;
replacing the first marks on the icons of all of the started applications with second marks when the system load of the electronic device is greater than or equal to the first predetermined value; and
displaying the second marks on the display area.

8. The system optimization method according to claim 7, further comprising:
closing at least one of the started applications; and
removing the second marks on the icons of the closed applications.

9. The system optimization method according to claim 8, further comprising:
checking whether the system load of the electronic device is less than or equal to a second predetermined value; and
recovering the second marks on the icons of the remaining started applications to the first marks when the system load of the electronic device is less than or equal to the second predetermined value.

10. The system optimization method according to claim 9, wherein the system load of the electronic device is a CPU utilization or a quantity of the started applications.

11. The system optimization method according to claim 8, wherein closing at least one of the started applications comprises closing the at least one of the started applications in response to a stop operation.

12. The system optimization method according to claim 7, wherein the first mark is a dot or a green highlight, the second mark is a line or a red highlight.

13. A non-transitory storage medium having stored thereon instructions that, when executed by a processor of an electronic device, causes the processor to perform a management method, wherein the method comprises:
adding a first mark on an icon of an application when the application is started in response to a starting operation of a user;
displaying the first mark on a display area of a display device on an electronic device;
checking whether a system load of the electronic device is greater than or equal to a first predetermined value;
replacing the first marks on the icons of all of the started applications with second marks when the system load of the electronic device is greater than or equal to the first predetermined value; and
displaying the second marks on the display area.

14. The non-transitory storage medium according to claim 13, wherein the method comprises:
closing at least one of the started applications; and
removing the second marks on the icons of the closed applications.

15. The non-transitory storage medium according to claim 14, wherein the method comprises:
checking whether the system load of the electronic device is less than or equal to a second predetermined value; and
recovering the second marks on the icons of the remaining started applications to the first marks when the system load of the electronic device is less than or equal to the second predetermined value.

16. The non-transitory storage medium according to claim 15, wherein the system load of the electronic device is a CPU utilization or a quantity of the started applications.

17. The non-transitory storage medium according to claim 14, wherein closing at least one of the started applications comprises closing the at least one of the started applications in response to a stop operation.

18. The non-transitory storage medium according to claim 13, wherein the first mark is a dot or a green highlight, the second mark is a line or a red highlight.
